(19) United States
(12) Patent Application Publication
(10) Pub. No.: US 2009/0222356 A1
(43) Pub. Date: Sep. 3, 2009

(54) PROPOSAL SUBMISSION SYSTEM AND METHOD

(76) Inventors: HUGUES COURCHESNE, Drummondville (CA); Charles Bombardier, St-Denis-de-Brompton (CA)

Correspondence Address: BENOIT & COTE, s.e.n.c., 1001, DE MAISONNEUVE BOULEVARD WEST, SUITE 210, MONTREAL, QC, H3A 3C8, CA

(21) Appl. No.: 12/465,918

(22) Filed: May 14, 2009

Related U.S. Application Data
(63) Continuation of application No. 11/954,632, filed on Dec. 12, 2007.
(60) Provisional application No. 60/869,593, filed on Dec. 12, 2006.

(51) Int. Cl. G06Q 30/00; G06Q 10/00; G06F 17/30

(52) U.S. Cl. 705/26; 705/400; 707/3; 707/E17.014; 707/E17.044

(57) ABSTRACT

There is described a method and system for submitting trade proposals. The method comprises, in a processing device accessible via a communication network: extracting a keyword from a quote request received via the communication network, from a remote server accessible on the communication network, the quote request initially entered by a buyer accessing digital content on the remote server; selecting a potential seller from multiple sellers, based on a comparison of the keyword with seller information associated with the multiple sellers; retrieving an address associated with the potential seller selected; sending a notification of the quote request to the address, over the communication network; creating a proposal submission entry upon the potential seller submitting a proposal in response to the quote request; and sending a notification of the proposal over the communication network, to the buyer, once the proposal submission entry has been created.

### CROSS-REFERENCE TO RELATED APPLICATIONS

This application is filed under 37 CFR 1.53(b) as a continuation-in-part application. This application claims priority under 35USC§120 or 365(c) of U.S. patent application Ser. No. 11/954,632, filed Dec. 12, 2007, and entitled “PRICE SUBMISSION SYSTEM AND METHOD”, which claims priority under 35USC§119 of U.S. Provisional Application Ser. No. 60/869,593, filed Dec. 12, 2006, entitled “PRICE SUBMISSION SYSTEM AND METHOD”, the specifications of which are hereby incorporated herein by reference in their entirety.

### FIELD OF ART

The invention relates to system and methods for the management of data communications over a network, between potential buyers, sellers, service providers and/or other intermediate parties, for the purpose of trading or exchanging goods and/or services. More particularly, the present application relates to system and methods for linking parties via customizable requests sent by either party.

### BACKGROUND

Many selling entities advertise over the Internet in order to promote their products and services for the purpose of making sales. Their presence can be established either through their own web site, via ads displayed in other affiliate web sites such as search engine web pages for example, or by registering and placing a classified advertisement on a community advertisement web site for example. Such advertisements may however not necessarily target all potential buyers because of their generic nature; thereby reducing chances of attracting a buyer looking for a more specific item and/or service. The inverse can also be said; buyers looking for a specific item and/or service, under specific conditions, have a hard time finding potential sellers or service providers.

There is hence a need to provide for a solution which addresses at least some of the above described shortcomings.

### SUMMARY

The present paper describes a system and method which seeks to link trading parties together over a communication network, in such a way that a potential buyer may more easily find sellers, and vice versa, who are able to provide what they are looking for. More particularly, the present application describes a proposal submission system and method for managing customized quote requests and proposal submissions over a communication network, for purchasing purposes.

By “customized quote requests” is meant any type of descriptive request which provides qualitative details as to what goods and/or services a given seeker is looking to purchase, while “proposal submissions” are meant to refer to any response addressing a demand as described in the quote request, by proposing terms and conditions in exchange for the desired good(s) and/or service(s). In this context, it is further submitted that the term “buyer” or “user” in this description is meant to refer to anyone or any party which submits a quote request, while the term “seller”, “retailer” or “provider” is meant to refer to any party or organization which has at least the potential to address a given quote request by sending a proposal submission (also referred to as a reply submission or price submission when pricing is involved).

In accordance with an embodiment, there is provided a proposal submission system comprising: a processing device for receiving a quote request via a communication network, from a remote server accessible via the communication network, the quote request entered by a buyer accessing digital content on the remote server. The system also comprises a memory device accessible by the processing device. The memory device in turn comprises instructions allowing the processing device to: extract a keyword from the quote request received; select a potential seller from multiple sellers based on a comparison of the keyword with seller information; retrieve an address associated with the potential seller selected; send a notification of the quote request over the communication network, to the address; create a proposal submission entry upon the potential seller submitting a proposal addressing the quote request; and send a notification of the proposal over the communication network, to the buyer, once the proposal submission entry has been created

In accordance with another embodiment, there is provided a method for submitting trade proposals. The method takes place in a processing device accessible via a communication network, and comprises the steps of: extracting a keyword from a quote request received via the communication network, from a remote server accessible on the communication network, the quote request initially entered by a buyer accessing digital content on the remote server; selecting a potential seller from multiple sellers, based on a comparison of the keyword with seller information associated with the multiple sellers; retrieving an address associated with the potential seller selected; sending a notification of the quote request to the address, over the communication network; creating a proposal submission entry upon the potential seller submitting a proposal in response to the quote request; and sending a notification of the proposal over the communication network, to the buyer, once the proposal submission entry has been created.

According to an embodiment, there is provided a fully customized method and system for a user to obtain a price submission for a specific item with specified qualifications, communicate with the retailers in order to negotiate and to possibly purchase the item through on-line payment systems or other means such as in-store or by mail and telephone.

According to an embodiment, there is provided a price submission system comprising: a recuperation module for gathering an email address of a retailer's website listed in a search result for a price query submitted by a user, the search result generated by an internet search engine; an email server for sending the price query to the retailer upon request from the user; a submission administration module for receiving a price submission from the retailer, for assuring the payment of a submission fee by the retailer, and for sending the price submission to the user; and a memory database for storing user and retailer information upon registration, as well as the search result, the price submission and the price query for consultation by the user and by the retailer.

According to another embodiment, there is provided a price submission system comprising: a recuperation module for gathering an email address from a retailer's website, having a corresponding retailer's website address resulting from a search query entered by a user; an email server for sending a price query to the email address, the price query entered by the user; and a submission administration module for transmitting a price submission to the user, the price submission sent by a retailer in response to the price query.

According to yet another embodiment, there is provided a price submission method comprising: a user entering a search query to obtain a list of at least one retailer's website; gathering an email address from the listed retailer's website; sending a price query to the email address, the price query entered by the user; a retailer responding to the price query with a price submission; and transmitting the price submission to the user.

In the description, the term “retailer” refers to anyone who sells items such as goods, products or services to the population at large or to specific markets. Retailers thus comprise particulars selling goods on Internet, through their own websites or through online reselling organizations.

### BRIEF DESCRIPTION OF THE DRAWINGS

FIG. 1 is a schematic illustration of a networking arrangement in which a proposal submission system is used in accordance with an embodiment;

FIG. 2 is a schematic illustration of the proposal submission system of FIG. 1, in accordance with an embodiment;

FIG. 3 is a schematic illustrating communication exchanges between parties, in accordance with an embodiment;

FIG. 4 is a block diagram showing steps taken in a method for submitting trade proposals over a communication network, in accordance with an embodiment;

FIG. 5 is a schematic of a networking arrangement in which a price submission system can be used, in accordance with another embodiment;

FIG. 6 illustrates the price submission system of FIG. 5 in greater detail, in accordance with an embodiment;

FIG. 7 illustrates the Internet Search Engine shown in FIGS. 5 and 6 in more detail, in accordance with an embodiment;

FIG. 8 is a block diagram showing various steps of a method in accordance with another embodiment; and

FIG. 9 illustrates communication exchanges between parties, in accordance with another embodiment.

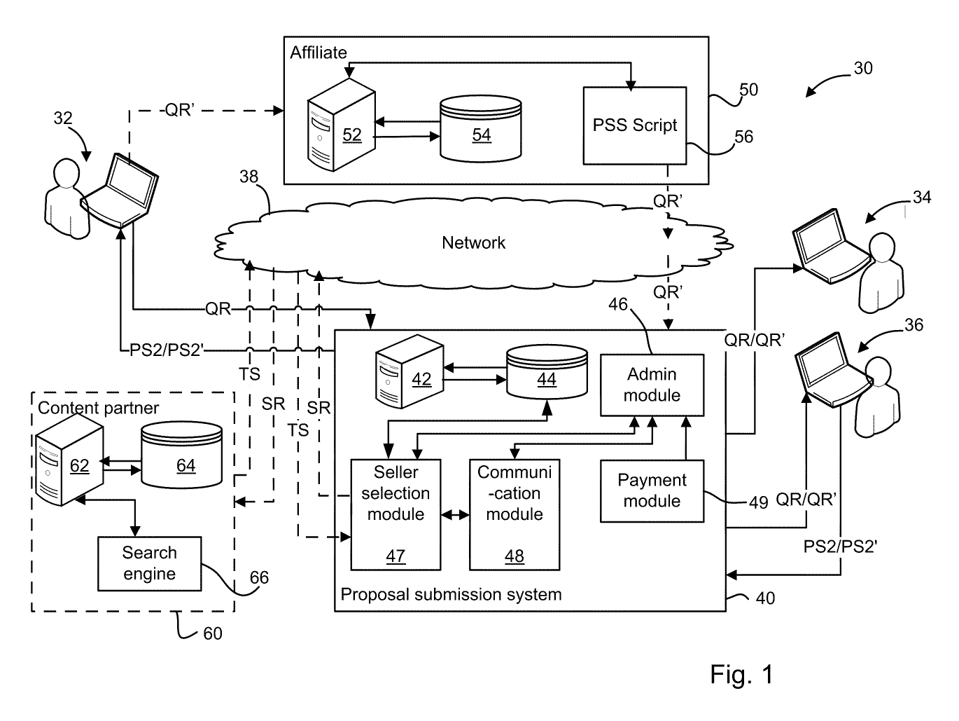

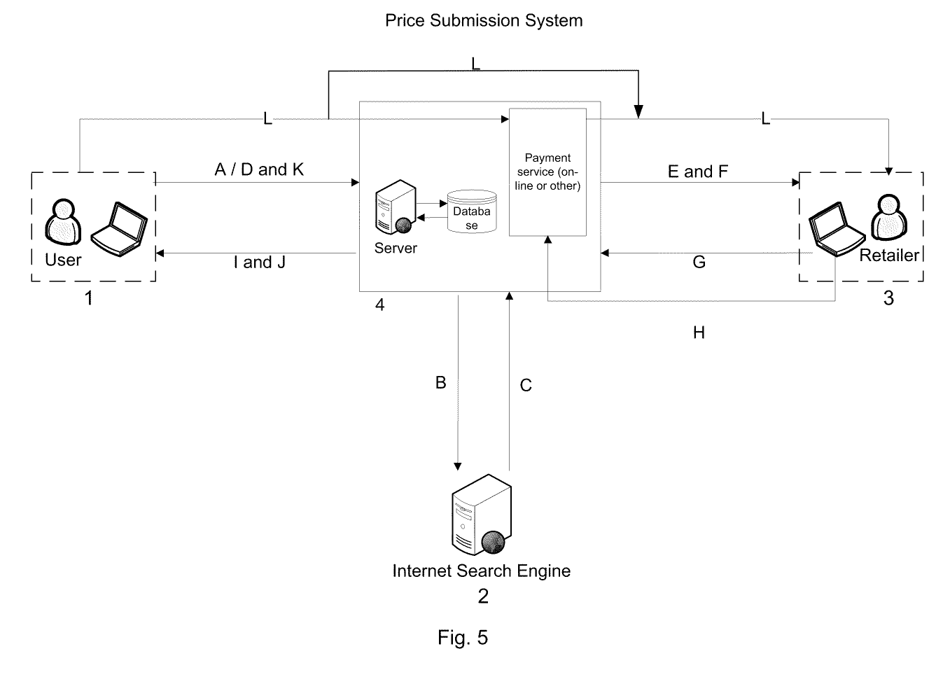

It will be noted that throughout the set of appended FIGS. 1 to 4, like features are identified by like reference numerals. The same applies to the group of FIGS. 5 through 9.

### DETAILED DESCRIPTION

Referring to the schematic of FIG. 1, there is illustrated a network arrangement 30 linking a potential buyer 32 and potential sellers 34, 36 together via a proposal submission system 40, over a communication network 38.

The system 40 links the potential buyer 32 by sending a quote request (QR) to a number of selected potential sellers 34 and 36. Each of the sellers 34 and 36 have the ability to receive the quote request QR and address it by sending a proposal submission (also referred to as a price submission when a price is involved), via the system 40. In FIG. 1, seller 36 for example, responds with proposal submission PS2.

The arrangement 30 also has an affiliate partner 50 and a content partner 60, also accessible via the network 38 and in communication with the system 40.

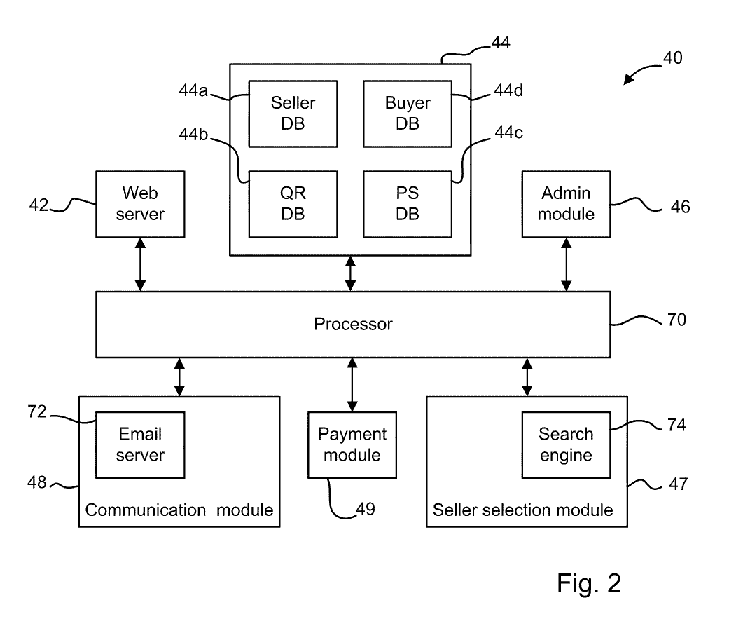

While the system 40 is illustrated in greater detail in FIG. 2, FIG. 1 schematically illustrates its various functionalities. In the embodiment of FIG. 1, the system 40 has a server 42; a memory device 44; an administration module 46; a seller selection module 47; a communication module 48; and a payment module 49.

The server 42 is a web server having access to the network 38, and which has the ability to host web pages or other digital content stored thereon or on the memory device 44 to create an online presence such as a web site for example. The memory device 44 can be a combination of multiple memory devices with databases for storing information such as buyer and seller information, quote requests and proposals, account balances, and any other information which is pertinent to the parties involved for the purpose of trading.

The administration module 46 associates quote requests (QR) received with the sending user (in this case the buyer 32) and its profile information entered upon registration with the system 40. Similarly, module 46 associates proposals (such as PS2) with the quote request (QR) it is meant to address and the seller information of the respective seller who submitted it (in this case 36). Information can be linked in a variety of manners, using linking tables and the like or any other form of pointer or index methodologies. Buyer and seller information has at least identification information and network address coordinates, but can also include usage information, keywords associated to the quote(s) or proposal(s) submitted by a party, or any other useful data associated with a party.

The seller selection module 47 is responsible for searching through the memory device 44 or other storage means (not shown) of the system 40, and selecting a list of potential sellers to whom a quote request (QR) is to be addressed and sent. The module 47 compares or matches keywords extracted from a quote request with seller information stored in the memory device 44 for example, or in other external, remotely located memory devices (not shown). Alternatively, the module 47 communicates with an external search engine present on a partner web site for example, to retrieve seller information available over the network 38. More details of this alternative approach are provided herein below.

The communication module 48 enables communication between all parties involved, over the network 38. Communication may be done via email, text messaging in accordance with various communication protocols, or other form of network communication. The communications are not restricted to written format.

The payment module 49 is responsible for the treatment of online purchases and the payment of various service fees such as a submission fee requested from a seller upon replying to a quote request, a registration fee or any other type of payment. The payment module is optionally linked to a financial institution and enabled to provide secured transactions.

The system 40 as shown in FIG. 1 can be embodied in various other manners different from those described hereinabove in relation to FIG. 1; the various modules are meant to represent a combination of processing device(s), or a single processor, programmed with appropriate coding or instructions which are stored and accessed on one or more memory devices in order to achieve their respective above-mentioned functionalities.

Still in reference to FIG. 1, the affiliate partner 50 has a web server 52 (also referred to as an affiliate server), a memory device 54 with a database storing web pages or other digital content hosted by the web server 52 accessible over the network 38. The affiliate 50 becomes a member of the system 40 by creating an affiliation and fixes a prescribed proposal submission fee any potential seller shall pay in order to be able to reply to a buyer who made a quote request via the affiliate 50. To this matter, a communication script illustrated by box 56 is optionally stored in the memory device 54, or in any other memory device not illustrated but accessible to the web server 52, to enable the buyer 32 visiting a web site of the affiliate partner 50 to enter, optionally register with the system 40 and submit a quote request to the system 40. Any alternative communication scheme can be used to allow access to the system 40 via any externally hosted web site such as the affiliate 50. Examples of communication schemes that may be used include application programming interfaces (API) offering a standard communication protocol with customizable integration.

Non-limiting examples of affiliate partners 50 are providers of services or products, such as manufacturers, reselling organizations, advertising organizations, web publishers, television providers, community portals, chatting sites, online blogs, picture posting sites, email or network connectivity service providers, professional or social linking sites, or any other web site of any party, member of an affiliate market for example. Affiliates offer their own users an access to the system 40 via any type of network, be it a wireless, telephone or Internet-based network. More specific examples of affiliates are: cellular telephone operators (such as Bell, Verizon™, Tmobile™, Rogers™); manufacturers of cellular phones, computers, etc. (such as Apple™, RIM™, Sony Ericsson™, LG™, Dell™, HP™, IBM™, Toshiba™); Internet providers (such as Sympatico™, Videotron™, NetZero™, Earthlink™); Web portals (such as Yahoo™, MSN™, AOL™); Search engines (such as Google™, Yahoo™, Live™, Ask™); or social networks (such as MySpace™, FaceBook™, Orkut™, Ning™).

The content partner 60 also has a web server 62, a memory device 64 with a database storing web pages or other digital content hosted by the web server 62 accessible via the network 38. The content partner 60 enables a search to be performed on data content stored in the memory device 64 or externally thereto. A search engine 66 is optionally used for such purposes. Alternatively, the search engine 66 can be provided by another online party. The data content of the partner 60 has information associated with multiple potential sellers or buyers. This information can be identification information such as names, geographic areas, interest categories, internet addresses or URLs, email addresses, physical mailing addresses, telephone numbers, and descriptions of the goods and/or services offered or of potentially interest. The content partner 60 can also represent an affiliate such as the affiliate 50.

Non-limiting examples of a content partner 60 include classified ads web sites, community web sites and online yellow pages or any other type of database which can be accessed online, or via the network 38, by the system 40. According to an embodiment, a percentage of the profits accumulated from the services offered by the system 40 optionally serves as payment to the content partner 60 for accessing its data content.

In FIG. 1, the presence of the affiliate 50 and the content partner 60 modules is however optional. In their presence, either of the affiliate 50 and the content partner 60 can be optionally adapted to be embodied within the system 40, structurally via a closed network accessible through network 38. The script 56 of affiliate 50 is also optional in that when the affiliate 50 is adapted to be implemented within the system 40, such a script may no longer be needed.

In addition and still in reference to FIG. 1, the network 38 can be any type of communication network such as any network which allows communication between a plurality of connected processing or computing devices, via cable, phone or power lines, optical fibers, wireless transmission, or any other suitable means. The network 38 can also be any type of area network or private network.

Now still in reference to FIG. 1, there is described an example of data exchange occurring when all the parties described are involved.

The buyer 32 enters a quote request (QR directly on the system 40 or QR′ from the web site of the affiliate 50). The QR′ is then transferred to the system 40 via the network 38 using the script 56, or directly if system 40 and the affiliate 50 are jointly implemented. When the QR or QR′ reaches the system 40, and when the buyer 32 optionally registers its information, the system 40 stores the QR (QR′) and optional buyer information, extracts keywords from the QR (QR′), and obtains a list of potential sellers which are assessed as being likely capable of meeting the buyer's request as stated in the QR (QR′). This can be done by comparing the keywords with data associated with a bank of sellers, as further described herein below. Once the list is obtained and the corresponding email addresses of each selected potential sellers are retrieved from a database, the QR (QR′) is sent over the network 38 to all of the selected potential sellers 34 and 36.

Once selected potential sellers 34 and 36 receive the QR (QR′) (or a notification that a QR has been received), each may decide to respond by accessing the system 40, registering their information with the system 40, and paying a prescribed submission fee to be able to enter a proposal submission (PS) in the system 40. In FIG. 1, the seller 36 is shown to enter a proposal submission (PS2) which may address the needs of the buyer 32 to potentially make a sale.

Once the proposal submission entry PS2 is created in the system 40 and the payment of the prescribed submission fee received, the system 40 determines from which site the corresponding quote request (QR, QR′) was entered by looking up quote request origin information which is stored in a database 44 upon entry of the quote request in the system 40. If the quote request is determined to have been entered by a user directly accessing the system 40 online (such as QR in FIG. 1), then the system 40 requests payment of a submission fee set by an operator or owner of the system 40. The system 40 then sends the PS2 directly back to the buyer 32, via email or through a notification which entices the buyer 32 to access the system 40 and retrieve the associated proposal PS2. Alternatively, and if the corresponding quote request was entered via the affiliate 50 such as is the case with QR′ in FIG. 1, the system 40 requests payment of a submission fee set by an operator or owner of the affiliate 50 site. Upon payment of this affiliate fee, system 40 sends the PS2′ to the buyer 32. In this way, the affiliate 50 sets the prescribed submission fee collected from a seller for being able to reply with a proposal submission to a buyer 32 that has submitted the QR′ from the affiliate 50 site. A same seller may respond to two quote requests each originating from a different affiliate site.

Still in reference to FIG. 1, the search of potential sellers can be performed by sending a search request (SR) over the network 38, to the content partner 60. The content partner 60 then accesses its own databases of seller information to find a match with keywords found in the QR and return a list of potential or target sellers (TS). The search request (SR) contains at least a keyword found in the QR (QR′) and other relevant information depending on a specific implementation used. Once the potential sellers are found and selected, and their respective identification information such as their addresses are obtained, the QR (QR′) is sent to each one of them and the sequence of subsequent actions follows those described in the preceding two paragraphs.

Now referring to FIG. 2, which shows a more detailed structural schematic of the system 40 of FIG. 1 in accordance with an embodiment, the system 40 has various memory databases: seller database 44a, quote request database 44b, proposal submission database 44c and buyer database 44d. Each of the elements stored in the databases can be linked together via pointers or tables stored thereon for easier retrieval and updating of information. All of these databases are in communication with a processing machine 70 implemented to perform a series of steps on the data stored in the various databases 44a to 44d. The processing machine 70 can be embodied as a separate machine as shown, or as processing power of the web server 42, once implemented to perform the desired series of steps as prescribed by each module 46 to 49.

The communication module 48 has an email server 72 to send email notifications over the network 38, to either or both of the sellers and buyers involved in a trade. In addition, the seller selection module 47 has a search engine 74 to search through the databases 44a to 44d, or through a database (not shown) of a content partner such as content partner 60 of FIG. 1, in order to select from a plurality of sellers, potential sellers who are most likely interested in replying to the quote request.

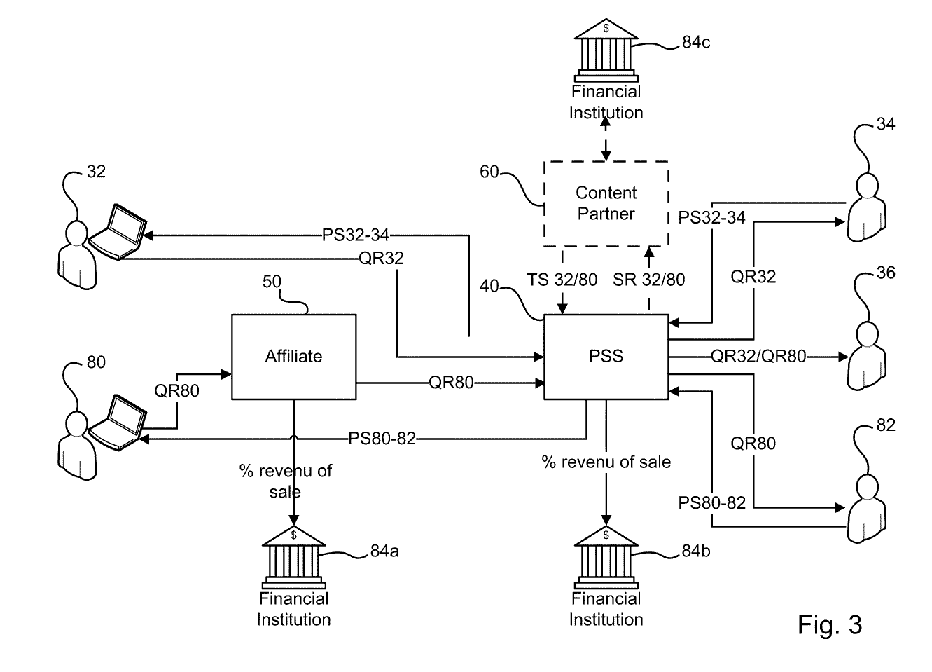

FIG. 3 illustrates communication exchanges between involved parties, in accordance with an embodiment where multiple buyers are involved.

Each of the affiliate 50, the system 40 and the content partner 60 are in communication with a financial institution 84a, 84b and 84c. Buyer 32 sends QR32 directly to the system 40 and buyer 80 sends QR80 via the affiliate 50. The system 40 extracts keywords from the QRs and performs searches in its own seller database, or optionally sends a search request SR with the keywords to an external content partner 60, to obtain a list of selected potential sellers (referred to as target sellers TS32 and TS80) for each quote request respectively.

Each one of QR32 and QR80 is sent to respective target sellers, here all of sellers 34, 36 and 82. In this example, seller 34 responds to the QR32 with a proposal submission PS32-34, seller 36 does not respond, and seller 82 responds to the QR80 with a proposal submission PS80-82. Depending on an origin of each QR32 and QR80, the system 40 requests from a seller either a system submission fee or an affiliate submission fee for responding with a proposal submission via the system 40. Upon payment, the system 40 sends the proposals back to the respective buyers. In the case of QR32, the proposal submission PS32-34 is sent back to the buyer 32 upon the seller 34 paying a system submission fee. In the case of QR80, the proposal submission PS80-82 is sent back to the buyer 80 upon the seller 82 paying a submission fee prescribed by the affiliate 50, or affiliate submission fee. A portion of this fee may be returned to the system 40 depending on arrangements taken between the affiliate 50 and the system 40's operators.

In an alternative approach (not shown), the PS80-82 is relayed to the buyer 80 via the affiliate 50. The affiliate 50 has the choice of altering the proposal before it is sent back to the buyer 80.

System 40 and affiliate 50 optionally split revenues made on submission or other services fees and sales as completed through the system 40. Each party may automatically or subsequently see their account with their own financial institution (or a common one) be updated accordingly. In one situation, the affiliate 50 and the system 40 both communicate their respective split revenues to their financial institution 84a and 84b which makes the necessary account changes. The content partner 60 may also communicate its revenue to its financial institution 84c, as provided by the system 40 for data access services. Each party's respective revenue is pre-negotiable and fixable in the system 40, in respect to each submission request or on a general basis.

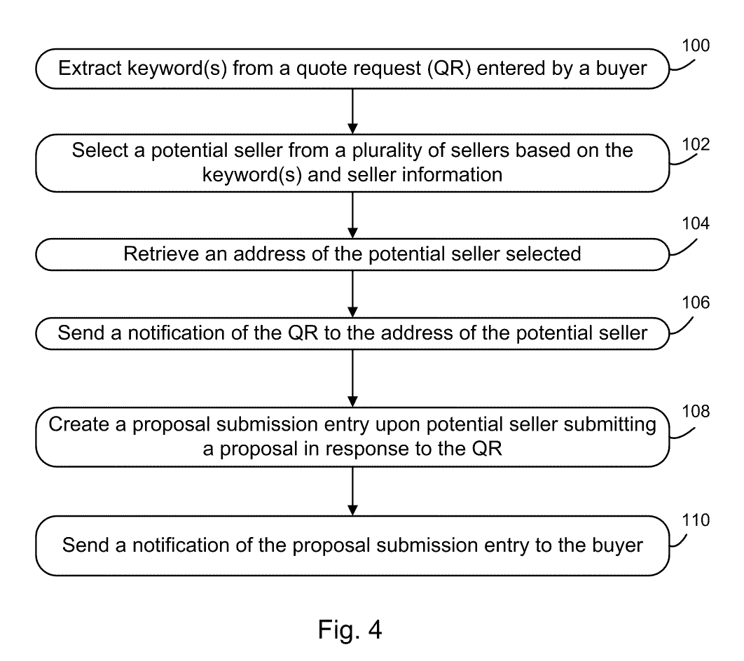

FIG. 4 is a block diagram of a method for submitting trade proposals over a communication network, in accordance with an embodiment. The method is embodied in a processing device adapted for access to the communication network, and implemented to perform the method in accordance with instructions stored on a memory device, the memory device being accessible directly or via the network.

In step 100, at least one keyword or a plurality of keywords are extracted from a quote request received. This is performed by a processing device or a server having access to a communication network. The quote request is initially entered by a buyer accessing digital content on a remote server, such as the server 52 of the affiliate 50 (refer to FIG. 1), via the network. A communication of the quote request or contents thereof, between the processing device and the remote server can be established by running a script on the remote server.

In step 102, at least one potential seller, or a group of potential sellers, is selected from a list of sellers. The selection is performed based on a comparison of, or by comparing and/or matching, at least one keyword extracted from the quote request with seller information associated with the multiple sellers on the list. For example, specific fields of a table associated with a group of sellers stored in a memory (such as memory device 44 in FIG. 1) are retrieved, consulted and compared to specific fields in another table associated with keywords of the QR, as extracted there from the QR. A minimum number of matches per seller may be set such that all the sellers for which the number of detected matches to one QR is above that minimum, are selected as potential sellers.

The seller information and the list of sellers can be retrieved from any database on a memory device accessible by the processing device, either directly or via the communication network. For example, the information, or a portion thereof, can be stored on a remote server or on another processing device accessible via the network. This is exemplified in FIG. 1 by web server and database 62 and 64 respectively of the content partner 60.

Still referring to FIG. 4, in step 104, an address associated with the potential seller selected is retrieved, such as an email address for example. The address can be retrieved from a memory device directly accessible, or through a remote processing device accessible via the communication network.

In step 106, the quote request, or a notification that a quote request is available to be viewed, is sent to the chosen potential seller, over the network. The quote request content or the notification is sent to the address retrieved in step 104. A separate email server can be used for such purposes.

In step 108, a proposal submission entry is created by the processing device for storage in memory, upon the potential seller submitting a proposal in response to the quote request. To submit a proposal, the potential seller needs only access the processing device via the communication network by following a link provided in the quote request notification for example.

In step 110, a notification, or contents of the proposal submitted by the potential seller is sent to the buyer once the proposal submission entry has been created in step 108. An email of the buyer can be used to send this notification, the email having been recorded in a database accessible by the processing device upon the buyer entering the quote request online.

Still referring to FIG. 4 and the above-described method, in step 108, when a proposal is received from a potential seller desiring to respond to the quote request, the potential seller submitting the proposal is optionally requested to register by entering its own seller information for storage onto a memory device accessible by the processing device. A submission fee is also requested for sending the proposal or a notification thereof to the buyer. Alternatively, the submission fee can be a percentage of a future sale to be realized between the potential seller and buyer.

Step 108 may involve a step of determining an origin of the quote request, using identification information about a remote server via which the quote request was originally entered to the system. The submission fee applicable for creating a proposal submission entry and replying to a quote request originating from an affiliated remote server, for example, is thus determined based on this identification information. A database table referencing applicable submission fees for different remote servers may be used to retrieve an applicable submission fee.

Referring now to FIGS. 5 to 9, in accordance with another embodiment, the system and method described herein also offers a potential client (also referred to as an Internet user or a buyer), the possibility to perform a search query for an item using an Internet search engine which provides a list of Internet website addresses of retailers possibly selling the specific item. This search query is performed for the system to send a user's price query for a specific item, to the listed retailers via email. The system and method described also permits the user to receive price submissions from the retailers who responded to his/her price query; to further negotiate with chosen retailers who responded; and to possibly buy the item from one of these retailers, at a given final price, using on-line services or other purchasing means.

In this embodiment, the retailers (also referred to as sellers), on the other hand, receive emails, via the system, from the Internet users who previously sent price queries for a product using the system. Once the retailers verify the pertinence of the queries, they can choose to subscribe to the system. A required subscription fee can be charged to the retailers, and paid using an available on-line payment module. Once subscribed, the retailers can then reply, via the system, to the Internet user who sent the price query and with which a sale may be achieved, by further paying a submission or reply fee.

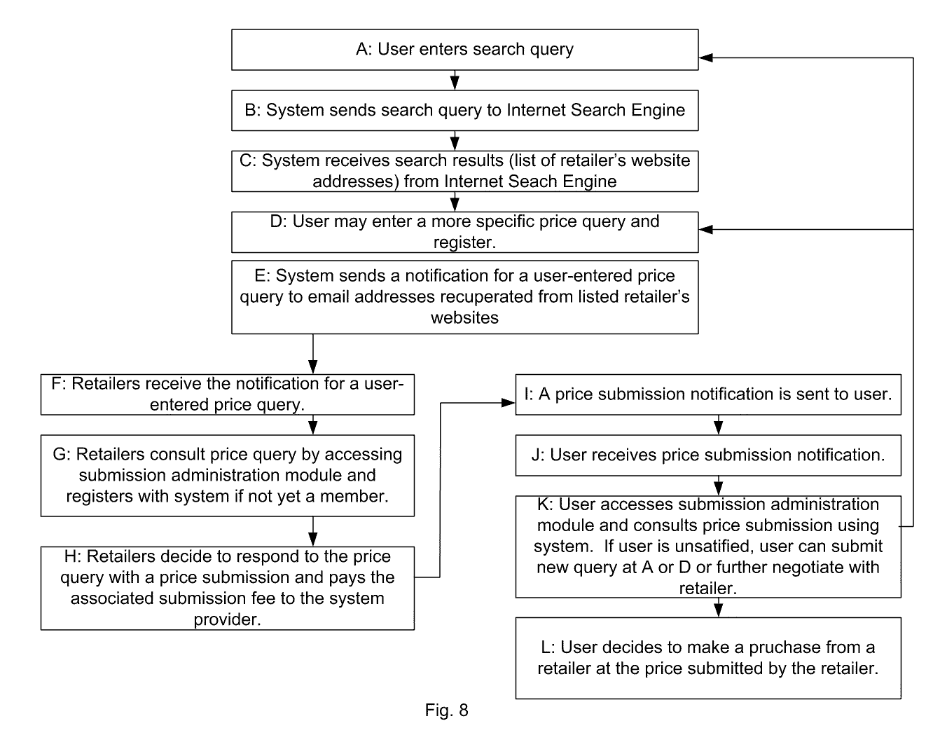

FIG. 5 fully illustrates the price submission and purchasing system 4. The letters refer to the steps of the method that is being implemented by the system 4, and according to one embodiment illustrated by FIG. 8. A user 1 enters search queries and/or price queries into the system 4. The user may enter search queries and price queries through various methods. A transcription module can be used to translate user's vocal queries captured by a microphone or a cellular phone into textual queries which are then sent to the price submission system. The system 4 works conjointly with a Search Engine 2 to obtain lists of retailers' website addresses or any link relevant with the enter search query, and recuperates the email addresses of all relevant retailers from their respective websites. The user 1 may then send a specific entered price query to all the relevant retailers at once via email. A price query can be so specific as to include a detailed description of the item desired, such as product specifications, quality, color, size, performance, origin, ingredients. Alternatively, if the item consists of a service, the price query can described what kind of service the user needs, such as coaching, medical assistance, counseling, cleaning, etc. A retailer 3 can then respond to the received price queries with an appropriate price submission by using the system 4 and paying a submission fee. The system 4 then transmits all price submissions to the user 1, who may decide to buy the item or perform another search.

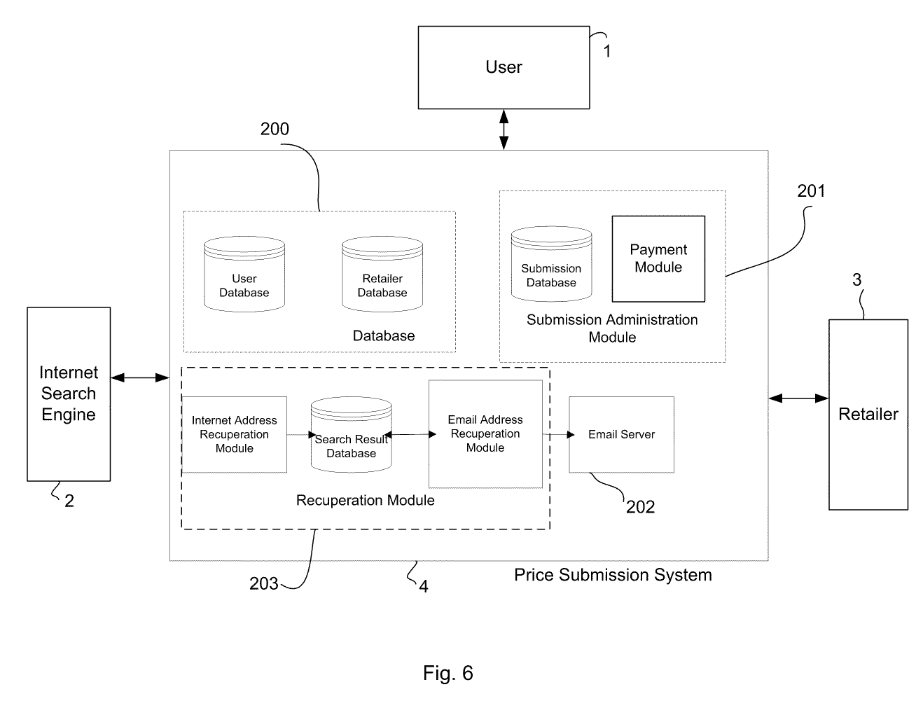

FIG. 6 illustrates the system 4 of FIG. 5 in greater detail. A database 200 is used to store all relevant user and retailer information obtained when a user enters a price query or whenever a user or a retailer registers with the system. The registration process is not mandatory. A submission administration module 201 manages all price submissions sent by retailers, along with the payment of the submission fee. A recuperation module 203 such as those known to persons skilled in the art, recuperates the retailers' website addresses (URL/Internet addresses) obtained from the search query results generated by the Internet Search Engine 2. The results can be stored in a database as well, which may be within the recuperation module 203 itself, or outside of this module. An email address recuperation module also forms part of the recuperation module 203 and recuperates all the email addresses found from the retailers' websites. The email server 202 can then send the price queries to the retailers' email addresses.

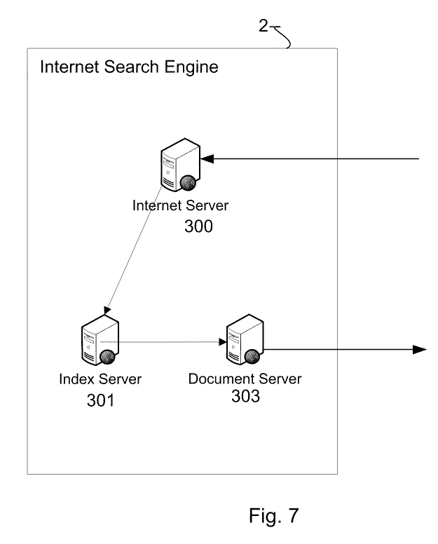

FIG. 7 illustrates the search engine 2 of FIG. 5 which receives a search query from the system 4. As an example, an internet server 300 receives the request for the search query and performs a search by communicating with an index server 301 and a document server 302. The search generates a list of relevant internet addresses which is sent to the system 4.

FIG. 8 details the method implemented by the system 4 of FIG. 5, according to a given embodiment. In A, the user enters a search query. The system sends the search query to an Internet Search Engine 2 in step B. In C, system 4 receives the search results generated by the Search Engine 2. This includes a list of relevant retailer's website addresses. Alternatively, the user may enter a search query directly into a Search Engine's web page, which then displays a list of relevant retailer's website addresses. The user can then enter a more specific price query within the system 4 at step D such that the system may send a notification of a price query to all the retailers' email addresses at step E. Note that the retailers' email addresses are first recuperated from the retailers' web pages by the recuperation module 203. Email addresses can also be obtained and stored during a retailer's registration process, which is not mandatory. Once the retailers receive the notification of a user-entered price query at step F, they may proceed with the consultation of the price query by accessing the submission administration module 201 of the system 4 at step G, and register if they are not yet a member and wish to become one. Registration permits the entrance of more information such as a different email address into the system, and may be promoted by giving certain advantages and prizes for example. Retailer registration information is stored in a database 200 and a registration fee may be demanded. At step H, the retailers decide to respond to the price query with a price submission which is also stored for later consultation. This requires the payment of a submission fee to the system provider and via a payment module within the system or, alternatively, from an online payment service. The price queries may alternatively be displayed directly on the notification email sent to the retailers, and registration may be done upon payment of the submission fee if the retailer decides to respond. At step I, a price submission notification is sent to the corresponding user, who receives this notification at step J, and consults the submission administration module 201 of the system 4 at step K to review all price submissions and lists of retailers. The user may decide to enter preferences into the system such that only retailers within a certain geographical area are notified and displayed. If the user is unsatisfied with the received submissions, new price and search queries may be performed by returning to either of steps A or D. If the user is satisfied, a purchase may be made at step L, directly from the retailer by in-store or telephone purchase for example, or through the system 4, and using any online payment services, or possibly from the retailer's website online purchasing system.

Further particularities of the method and system described in reference to FIGS. 5 to 8, are described hereinbelow. According to an alternate embodiment, step A can take the form of step D described above, as the user 1 may first enter a price query for a specified item: a key word or a key sentence describing the item, his or her email address or contact information such as a telephone number or a mailing address, and perhaps a specific price request or range of prices. All user-entered information, including all queries, is stored in a database 200. In step B, the key words or key sentence entered by the user are sent by the system 4 to a search engine 2 which generates a list of internet addresses of retailers possibly selling an item similar to the one described by the user 1 in the price query. In step C, the system 4 gathers all the internet addresses generated by the search engine 2 and stores them in a memory device. Jumping to step E of FIG. 8, the system 4 then sends emails to all the email addresses corresponding the gathered internet addresses to inform the retailer 3 that a user 1 requires a price for the specified item. Once steps F and G are done, the retailer decides to respond to a price query received and thus pays the submission fee necessary to reply to the user 1 in step H. Again in step H, the retailer 3 sends a reply to the user 1, through the system 4, and offers the item at a certain price to possibly make a sale. The system 4 then transmits the price submission response to the user 1, as described in step I. Upon consideration of the replies received at step K, the user then possibly decides to buy the product at the offered price in step L. The retailer 3 then receives the payment of the item and sends to purchased item to the user.

Still in reference to FIGS. 5 to 8, and in accordance with yet another embodiment, when an internet user 1 performs a search for an item at step A by entering a search query, the user can do so by directly using a search engine 2. Once the search is performed and the list of relevant retailers' websites is displayed (steps C), the internet user has the possibility to click on a specific link for getting a price for that same item along with further specifications (step D: this user-entrance is referred to as a price query), and from the commercial retailers listed in the search result. Hence, when the user clicks on this link, another window or same window opens asking the user to enter his email address and a possibly more specific description of the product for which the users desires to obtain a price. The further specified product is at least related to the item originally searched for using the search engine (the price query has some relation to the first search query). Once the user clicks on the send button, the system 4 obtains all the email addresses of the URL addresses listed in the first search results, generic or sponsored, and sends the price query to all these addresses (step E). When the retailer 3 receives an email informing him that there is a potential buyer asking a price for a specific product (step F), the retailer 3 can subscribe to the system in order to reply to the potential buyer or internet user (step G) and possibly make a sale. Each time the retailer 3 answers a price query by sending an email to an internet user 1 asking for a price submission, the retailer must pay a certain fee to the provider of the system 4 (step H). Upon receipt of price offers from a list of retailers, the user may choose to proceed with the acquisition of the product from one of the retailers and at the price submitted using an on-line payment service, or to contact the retailer to negotiate. If the payment is made online, the retailer 3 then receives the information concerning the order along with the payment, and can thus send the product to the user 1.

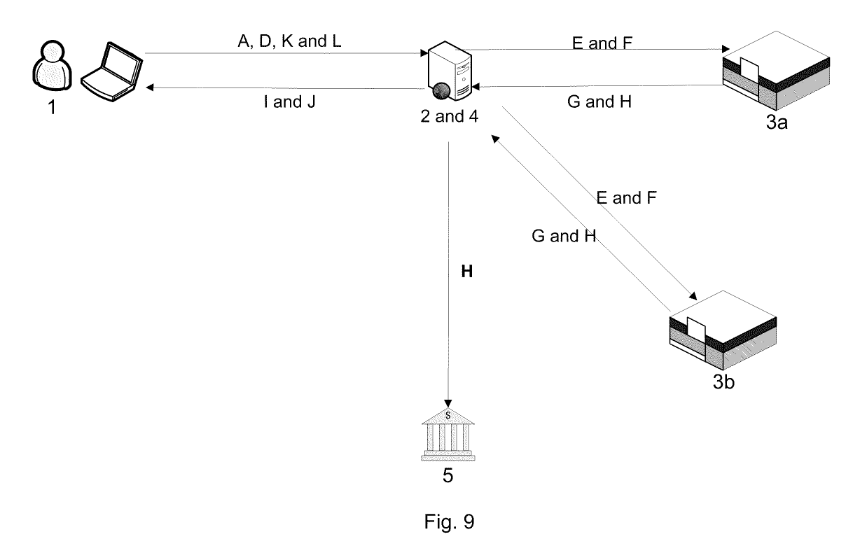

FIG. 9 illustrates, in accordance with an embodiment, how the price submission system 4 of FIG. 5, and the method described in reference to FIG. 8, enables the communication of more than one retailer 3a and 3b, along with a financial institution 5 for the payment of the submission fee by both retailers 3a and 3b. The fees may be pre-defined according to various criteria, and the payment can be performed each time a reply price offer is sent to a user 1, or credited from a retailer's account which may be paid on a monthly basis, for example. Any other type of rewarding or payment strategy can be implemented by the system and method described herein.

The embodiments of the invention described above are intended to be exemplary only. The scope of the invention is therefore intended to be limited solely by the scope of the appended claims.

What is claimed is:

1. A proposal submission system comprising:
a processing device for receiving a quote request via a communication network, from a remote server accessible via the communication network, the quote request entered by a buyer accessing digital content on the remote server; and
a memory device accessible by the processing device, the memory device comprising instructions allowing the processing device to:
extract a keyword from the quote request received;
select a potential seller from multiple sellers based on a comparison of the keyword with seller information;
retrieve an address associated with the potential seller selected;
send a notification of the quote request over the communication network, to the address;
create a proposal submission entry upon the potential seller submitting a proposal addressing the quote request; and
send a notification of the proposal over the communication network, to the buyer, once the proposal submission entry has been created.

2. The system of claim 1, wherein the memory device further comprises instructions for the processing device to request a submission fee from the potential seller before: creating the proposal submission entry and sending the notification of the proposal.

3. The system of claim 2, wherein the memory device further comprises identification information about the remote server via which the quote request was entered, the instructions further comprising determining an amount of the submission fee based on the identification information.

4. The system of claim 1, wherein the remote server further comprises another processing device for running a script thereon to establish a communication between the remote server and the processing device.

5. The system of claim 1, wherein the remote server and the processing device communicate via an application programming interface (API).

6. The system of claim 1, wherein the remote server is an affiliate server operated by a provider of one of a service and a product.

7. The system of claim 1, wherein a portion of the seller information is stored on another remote server accessible by the processing device via the communication network.

8. The system of claim 7, wherein the memory device further comprises instructions for the processing device to one of: perform a search on the other remote server, and request that the search be performed by the other remote server; and
wherein, the potential seller is selected based on a result of the search.

9. The system of claim 8, wherein the network address is retrieved from the other remote server.

10. A method for submitting trade proposals, the method comprising:
in a processing device accessible via a communication network,
extracting a keyword from a quote request received via the communication network, from a remote server accessible on the communication network, the quote request initially entered by a buyer accessing digital content on the remote server;
selecting a potential seller from multiple sellers, based on a comparison of the keyword with seller information associated with the multiple sellers;
retrieving an address associated with the potential seller selected;
sending a notification of the quote request to the address, over the communication network;
creating a proposal submission entry upon the potential seller submitting a proposal in response to the quote request; and
sending a notification of the proposal over the communication network, to the buyer, once the proposal submission entry has been created.

11. The method of claim 10, further comprising requesting a submission fee from the potential seller before: the creating of the proposal submission entry and the sending of the notification of the proposal.

12. The method of claim 11, wherein the requesting of a submission fee comprises retrieving identification information about the remote server via which the quote request was initially entered, the submission fee being based on the identification information.

13. The method of claim 10, wherein the selecting comprises one of:
performing a search on another remote server accessible via the communication network, the other remote server having access to at least a portion of the seller information; and
requesting that the search be performed by the other remote server on at least the portion.

14. The method of claim 13, wherein the retrieving of the address comprises retrieving an email address from the other remote server.

15. The method of claim 10, further comprising running a script on the remote server, to establish a communication of the quote request from the remote server to the processing device.

16. The method of claim 15, wherein the remote server is an affiliate server, and further comprising the affiliate server requesting a submission fee from the potential seller before: the creating of the proposal submission entry and the sending of the notification of the proposal, by the processing device.

17. The method of claim 10, further comprising establishing a communication with the remote server via an application programming interface.
